(19) United States
(12) Patent Application Publication
(10) Pub. No.: US 2015/0181282 A1
(43) Pub. Date: Jun. 25, 2015

(54) MULTIPLE LOCATION CHANNEL DATABASE FOR DIGITAL TELEVISION SYSTEM AND METHOD

(71) Applicants: Mahmood Majid, Lakeville, MN (US); Newton Guillen, Plymouth, MN (US)

(72) Inventors: Mahmood Majid, Lakeville, MN (US); Newton Guillen, Plymouth, MN (US)

(73) Assignee: BBY SOLUTIONS, INC., Richfield, MN (US)

(21) Appl. No.: 14/133,850

(22) Filed: Dec. 19, 2013

(51) Int. Cl. H04N 21/438; H04N 21/426; H04N 21/45; H04N 5/50; H04N 5/44

(52) U.S. Cl. CPC H04N 21/4384; H04N 5/50; H04N 5/4401; H04N 21/4524; H04N 21/4263

(57) ABSTRACT

A digital television is presented that stores multiple channel maps in its channel memory. Each map is associated with a particular geographic location. When the television moves to a new location, the location is identified and the television examines its memory for stored channel maps relevant to that location. If a relevant channel map is found, it is used without the television having to rescan the available television frequencies to create a new map for that location. When scans are required, they are expedited by examining a database of relevant frequencies for the television's location. The database identifies frequencies that are in use by television broadcasters near that location. The television then needs to scan only those frequencies identified in the received list, which reduces scan times.

### FIELD OF THE INVENTION

The present application relates to the field of digital televisions. More particularly, the described embodiments relate to the scanning of digital television broadcast signals to set up a channel map within the television.

### SUMMARY

One embodiment of the present invention provides storage for multiple channel maps within a single digital television. Whenever a digital television is used in a new location, the television must scan the available frequencies in order to fill out a channel map of the available over-the-air digital television (“DTV”) channels. Rather than having a new scan of available frequencies write over the old channel map, the present invention stores multiple channel maps, each of which is associated with a particular geographic location. When a user moves the television to a new location, the television identifies its current location and examines its memory for stored channel maps relevant to that location. If a stored map is found, the stored map can be re-used without requiring the television to rescan the available television frequencies to create a new map for that location.

In another embodiment, each scan of the available frequencies is expedited by examining a database of relevant frequencies for a geographic location. When beginning a channel scan, the television identifies its current location and queries a database using that location. The database responds to the query by listing all frequencies in use that may be received at the current location of the television. The television then scans the frequencies in the received list rather than all possible frequencies that may contain a digital television signal. Since the list of relevant frequencies will contain fewer than all possible frequencies, the scanning time for the digital television will be greatly reduced.

### BRIEF DESCRIPTION OF THE DRAWINGS

FIG. 1 is a schematic diagram showing one embodiment of the present invention including a digital television containing a DTV receiver.

FIG. 2 is a schematic diagram of the contents of a channel memory in the DTV receiver of FIG. 1.

FIG. 3 is a flowchart showing a method of utilizing pre-stored channel maps when returning a DTV receiver to geographic location of a previous channel map scan.

FIG. 4 is a flowchart showing a method for performing a channel map scan utilizing a database of relevant frequencies for a geographic area.

### DETAILED DESCRIPTION

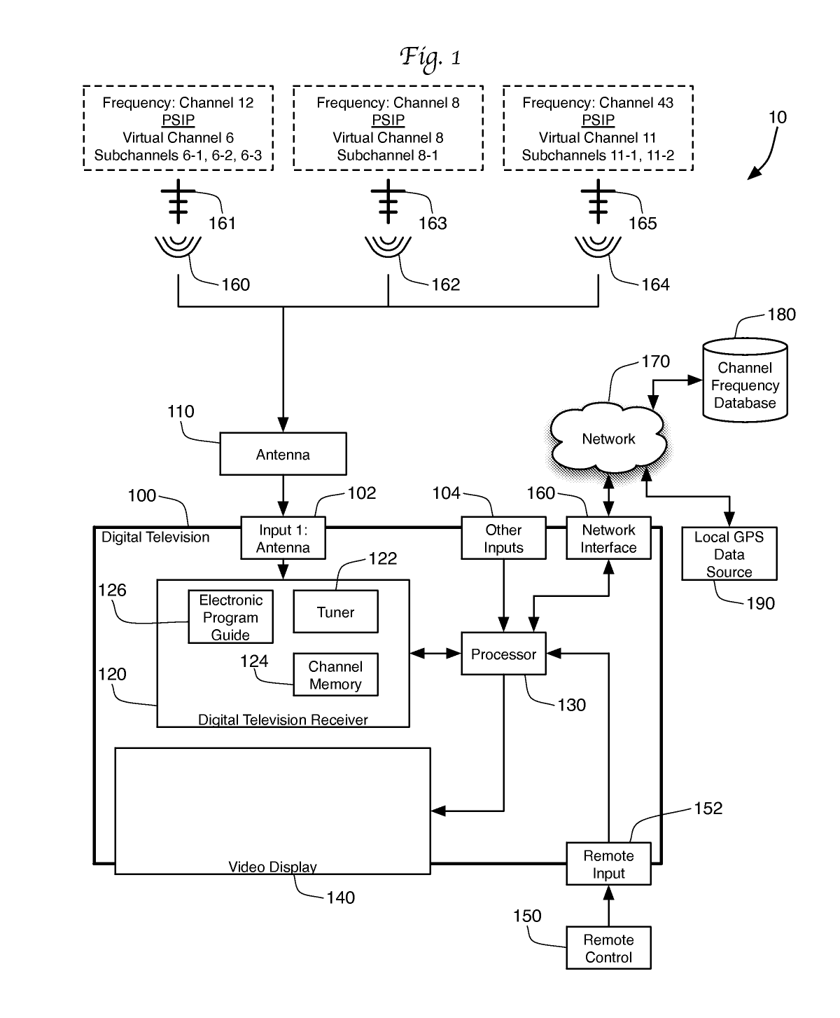

FIG. 1 shows a system 10 in which a digital television (or “DTV”) 100 is receiving three digital television broadcast signals 160, 162, 164. These television signals 160, 162, 164 are shown in FIG. 1 as being broadcast over antennas 161, 163, and 165, respectively. Each broadcast signal 160, 162, 164 is being transmitted at a different radio frequency. Since 2009, digital television signals in the United States are transmitted over the same VHF and UHF channel frequencies that used to transmit analog television signals. In FIG. 1, antenna 161 is transmitting digital television signal 160 over the VHF channel 12 frequency (205.25 MHz). Similarly, signal 162 is being broadcast over the VHF channel 8 frequency, and signal 164 is being broadcast over the UHF channel 43 frequency.

Although DTV channel 160 is being transmitted over channel 12, it is able to present itself to users through the digital television 100 as channel 6. In the United States, this is accomplished using “virtual channels” implemented using the PSIP (the “Program and System Information Protocol for Terrestrial Broadcast and Cable”) protocol created for ATSC broadcasting. Most television broadcasters strongly branded themselves according to their analog television signal frequency (using slogans such as “you are watching Channel 5”). When these broadcasters transitioned to digital television transmissions, they frequently choose to broadcast their DTV signals over a different channel frequency for economic or technical reasons. These broadcasters can use virtual channels to hide the actual radio frequency of their broadcasts from their viewers. Thus users of television 100 will interact with broadcast signal 160 as if it were “channel 6” even though the signal 160 is being broadcast over the radio frequency (“RF”) of channel 12. The PSIP protocol also carries other metadata about the DTV signal 160, including content ratings for material currently being broadcast, and electronic program guide information with titles and descriptions for current and future broadcasts. The PSIP information broadcast in the DTV signals 160, 162, 164 also includes the current time and short, alphanumeric names that a television station can use to identify its channels.

Many DTV signals 160, 162, 164 include more than one independent program multiplexed into a single broadcast signal. Broadcast signal 160, for example, contains three sub-channels identified in the PSIP information as virtual channels 6-1, 6-2, and 6-3. Similarly, signal 164 is broadcast over antenna 165 on UHF channel 43 containing sub-channels 11-1 and 11-2. As with signal 160, these sub-channels can be identified with virtual channel 11 through the use of PSIP information even though the signal 164 is broadcast over RF channel 43. In contrast, signal 162 does not use a virtual channel technique to broadcast its signal 162 on a different RF channel than that which will be displayed to users. Nor does this signal 162 contain multiple programming sub-channels. Instead, signal 162 is broadcast over RF channel 8 and contains only a single channel (namely channel 8-1).

All three of these signals are received by digital television 100 through the use of an external antenna 110. The signals received by the antenna 110 are input into the digital television 100 through the television's antenna input 102 and decompressed and interpreted by a digital television receiver 120. In the embodiment shown in FIG. 1, the receiver 120 forms part of the television 100 (that is, the components of the receiver 120 are found internal to the television 100). In other embodiments, the receiver 120 may be found in a component separate from the television 100, usually taking the form of a set-top-box.

The television 100 also includes other inputs 104, which may take the form of composite inputs, component inputs, or HDMI inputs 104. These inputs 104, and the output of the television receiver 120 are received by a processor 130 that is responsible for processing these video signals so that they may be displayed on the video display device 140 built into the television 100. The user can select between the inputs 102, 104 and also control the digital television receiver 120 through the use of a remote control 150. The remote control 150 sends an infrared or radio frequency signal to the remote input 152 of the television 100, which then forwards the command to the processor 130 for processing.

The television 100 also includes a network interface 160, which allows the processor 130 to communicate with remote electronic devices 180, 190 over a network 170. In one embodiment, the network 170 may be a local area network such as a local WiFi network operating under one of the IEEE 802.11 protocols. For example, the processor 130 may wish to identify its current location by connecting with an app running on a mobile device 190 that is connected to the same local area network 170 as the television 100. This device 190 may include a GPS system or another technique for identifying its geographic location. The processor 130 can communicate with the app running on device 190 over the network interface 160 and the network 170 in order to obtain this location for the benefit of the television 100.

The network 170 may connect to and form part of a wide area network such as the Internet. With this configuration, the television 100 can communicate with a remotely located database 180 over the Internet using its network interface 160. Although not shown in FIG. 1, the database 180 will likely be implemented using a server computer (or computers) that is accessible over the network 170, wherein the server computer manages the database 180 using a non-transitory storage device. As explained below, the television 100 can make use of this channel frequency database 180 to reduce channel scan times.

Returning the digital television receiver 120, FIG. 1 shows that the receiver 120 includes a tuner 122. The tuner 122 is responsible for handling and interpreting the signals received through the antenna input 102. The receiver 120 also contains a channel memory 124 and an electronic program guide (or “EPG”) component 126. The EPG component 126 is responsible for obtaining programming information from the digital television signals 160, 162, 164, arranging this information, and then presenting the information to the user over video display 140.

In the United States, digital television channels are broadcast on 68 different frequencies, namely on VHF and UHF channels 2-69 at frequencies between 54 and 806 MHz. Because of the digital nature of these broadcasts and the requisite packet reconstruction and decoding, a digital television receiver 120 may take up to a few seconds to change from one RF channel to the next. If the user was forced to traverse RF channels that are unoccupied by broadcast signals 160, 162, 164 in order to move from one signal 160 to another 162, this delay would create an almost unbearable user experience.

Because of this, almost all digital televisions require (or strongly suggest) that a user scan for available channels before using the television 100 at a particular location. To accomplish this scan, a typical television 100 will tune to each of the available channels (channels 2-69 in the United States) looking for broadcast television signals 160, 162, 164. When a broadcast signal is found, the signal is analyzed to identify sub-channels, virtual channel assignments, and broadcast station identifiers associated with that signal. When this information has been gathered for a discovered broadcast signal, the information is stored in a channel map and the channel scan continues. Channel scans of all 68 over-the-air DTV channels in the United States can take over 30 minutes to accomplish in some present-day televisions. When all of the possible channels are scanned, the discovered channels found in the channel map are made available to a user. Unused RF channel frequencies are excluded from the map so that the user will not waste time traversing unused RF channels. By using a channel map, a user can direct the television to go “up” or “down” a channel, and the television will move only between available channels sorted and displayed according to their virtual channel information. The channel map is generally stored in non-volatile memory 124 so that the map is not forgotten when power is removed from a television.

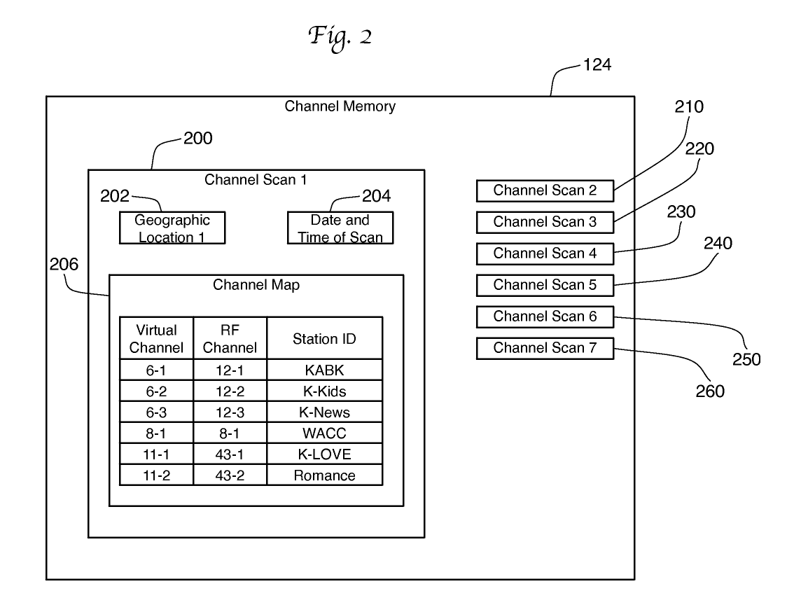

In the preferred embodiment, the channel map is stored in channel memory 124 after each channel scan. As shown in FIG. 2, a channel scan 200 associates the channel map 206 with a geographic location 202 and a date and time 204 for the channel scan. The geographic location 202 can be obtained by communicating with an external mobile device 190 such as a smart phone, a tablet computer, or a personal computer. In one embodiment, the user of a television 100 would be requested to download a special purpose app on their mobile device 190. Using the app, the mobile device 190 would enter into a network connection with the television 100, which would allow the television 100 to obtain its geographic location 202 from the mobile device 190. In alternate embodiments, the television 100 itself would contain a location-identifying device utilizing a GPS receiver or Wi-Fi identification algorithm. A Wi-Fi identification algorithm identifies Wi-Fi networks that are visible through network interface 160 and consults an external database to associate discovered networks with a geographic location. In other embodiments, the television 100 would simply present a user interface through video display 140 asking the user to identify the current location of the television 100 (such as by entering a zip code or city/state combination).

The channel map 206 associates each virtual channel with the radio frequency at which the channel is found, as well as other PSIP information found in the broadcast signals such as station identifier text. The channel map 206 shown in FIG. 2 represents the three broadcast signals 160, 162, 164 that are received by the television 100 in FIG. 1.

Most standard televisions store only a single channel map 206 at a time. In the embodiment shown in FIG. 2, the channel memory 124 contains information about a plurality of channel scans 200, 210, 220, 230, 240, 250, and 260 each of which contains a different channel map. Channel scan 200 is shown containing a specific geographic location 1 (202) that identifies where the channel map 206 was created. Each of the other channel scans 210-260 identifies a different geographic location, which reflects the fact that this television 100 has frequently moved to new locations. This type of situation is common when a television 100 is mounted in vehicle such as a camper or RV, or when the television is itself portable. Because each new location means that a different set of DTV signals will be received at these locations, each move requires that the television perform a new channel scan and create a new channel map. The channel memory 124 is large enough to contain information from a plurality of channel scans 200-260.

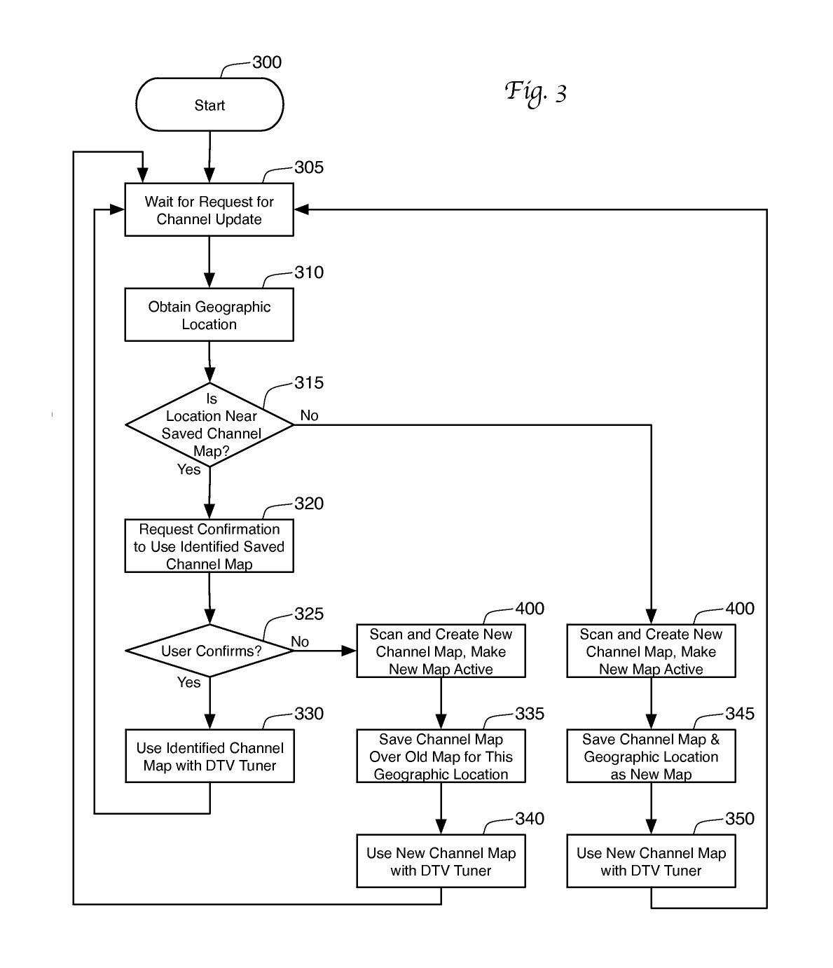

By storing multiple channel maps each in association with a separate geographic location, the digital television 100 can avoid unnecessary channel scans. The method 300 shown in FIG. 3 shows one technique for avoiding redundant scans. The method begins at step 305, at which the television 100 waits for a command to rescan for available broadcast signals (such as signals 160, 162, and 164). This command is generally received through the user interface of the television 100, such as by a command received from the remote control 150 over the remote input interface 152.

Once the request to scan for available channels has been received, the digital television 100 determines its current geographic location at step 310. As explained above, this can be accomplished by accessing an external but nearby device that has its own location determination capabilities, such as a nearby smart phone or tablet computer 190. Alternatively, the television 100 can use its own internal resources to determine its location, such as by using an internal GPS device or WiFi-based positioning system. Finally, the television 100 can simply request the user to input the current location of the television, such as by having a user input the zip code of the current location using the remote control 150.

At step 315, the television 100 compares the location determined at step 310 with the locations (such as location 202) in each of the stored channel scans 200-260 stored in its channel memory 124. Step 315 attempts to determine whether the current television location is the same as, or sufficiently near to the location of one of the previous channel scans 200-260, which would mean that that channel scan is applicable to the current location of the television 100. How near the locations must be to be “sufficiently near” can be determined through trial and error with the particular television 100 and antenna 110 combination. In some embodiments, the user can alter this acceptable distance through preference settings stored within the television 100. In other embodiments, a default distance is applied to all circumstances. The “sufficiently near” distance should be such that the particular broadcast signals 160-164 received by the television 100 should not change when the television 100 has been moved by that distance. An example range may be seven miles.

If one of the channel scans 200-260 stored in the channel memory 124 are sufficiently close to the current location of the television 100, the method 300 continues to step 320. At this step 320, the user is notified that a previous scan of available channels was already performed by the television 100 and could be used immediately without requiring a new scan. The user is given the option to use this previously saved scan, or to have the television 100 perform a new scan. If multiple channel scans are determined to be close enough in step 315 to be useful for the current location, the digital television 100 can select the “best” scan or can present all of the useful scans for selection by the user in step 320. The “best” scan may be the scan that took place geographically closest to the current location of the television 100, or the scan that took place most recently.

If the user confirms use of the relevant scan (or one of the relevant scans if multiple scans are presented to the user), then step 330 makes the channel map from that scan (such as map 206) the active channel map for the television 100. In other embodiments, the confirmation step 325 would be skipped and step 320 will always be followed by step 330. In this way, a user is able to move between previously visited geographic locations and immediately use the television 100 to receive local digital television broadcasts 160, 162, 164 without requiring a slow and frustrating channel scan. The method 300 would then return to step 305 to await a request for a new channel scan.

If the user does not wish to use the identified channel scan for this geographic location at step 325, then the method 300 causes the television 100 to scan the over-the-air television broadcasts and create a new channel map for the current geographic location. This can be done in the conventional manner of scanning all possible frequency channels (channels 2-69 in the United States). Alternatively, a preferred method 400 can be used to perform this scan, which is described in more detail below. After the new channel map is created, step 335 saves this new channel map along with the television's current geographic location and a time stamp for the scan in the channel memory 124. In one embodiment, only one scan 200-260 is stored in the channel memory 124 for each geographic location. As a result, this embodiment will not only save the new scan at step 335, but it will also delete the previous scan for this location from the channel memory 124. In other embodiments, previous scans are not deleted until manually deleted from the channel memory 124 by the user or until space is needed in the channel memory 124 for additional scans. If multiple scans for the same geographic location are stored in the channel memory 124, step 320 can present all relevant scans and their scan dates to the user in step 320 to allow the user to select an older scan if desired. After step 335, the new channel map is used as the current map for the television 100 (step 340), and the method 300 returns to step 305 to await another request for a channel scan update.

If step 315 did not identify any channel scans 200-260 that were performed near the present location of the television 100, then it is necessary to perform a new scan of the digital broadcast frequencies. Preferably, this is accomplished using method 400 below. After the new channel map is created by this method, step 345 will save the map with the current time and location of the television in the channel memory 124 as a new channel scan. Because step 315 did not find any relevant channel scans in channel memory 124, there is no need for step 345 to overwrite an existing channel scan for the current television location. At step 350, the new channel map is assigned to be the current map for the television 100, and the method 300 returns to step 305.

In an alternative embodiment, the digital television 100 need not wait for a request for a channel update in step 305. Instead, the digital television uses an internal or external location sensor to determine that the location of the television has changed. If the new location is determined to be near a saved channel map at step 315, television 100 can simply update its channel map to reflect the new geographic location of the television (or can do so after confirmation by the user).

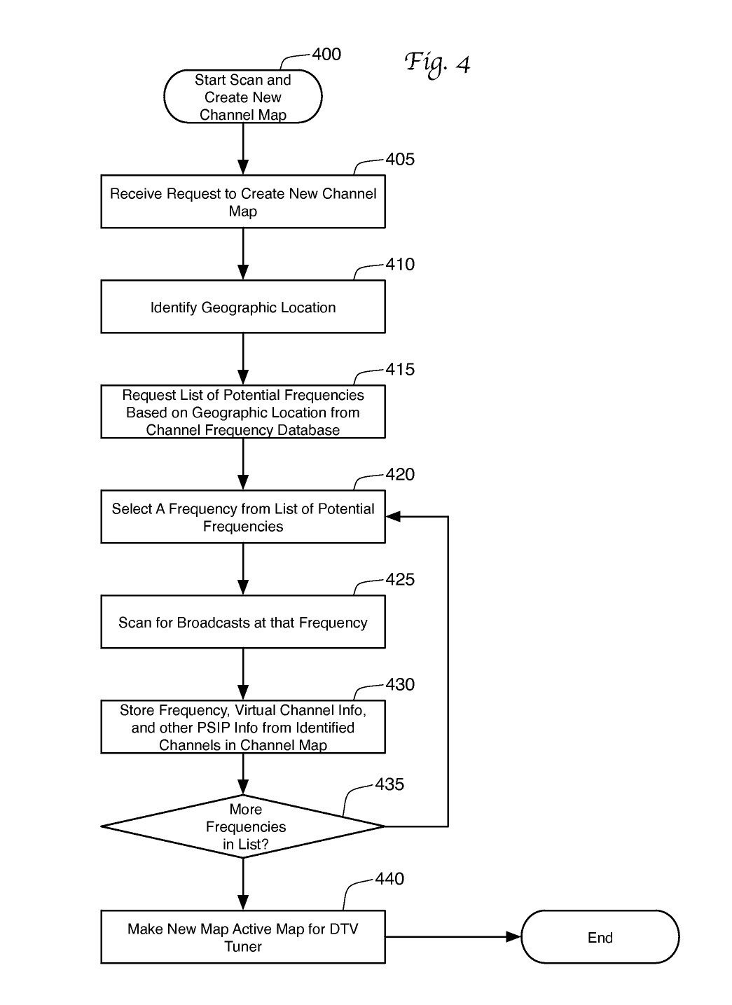

FIG. 4 shows a method 400 for creating a new channel map. The method 400 begins at step 405 with a request to create a new channel map. As explained above, this request can come from within method 300. Alternatively, method 400 can be used in a television 100 that does not implement method 300, in which case the request 405 may come from a user interface request to replace the current channel map with a new channel map. After the request is received, the television 100 identifies its current geographic location in step 410. If method 400 was called immediately after method 300 performed step 310, the identified geographic location from that step can be used in step 410. If not, the television 100 can use any of the techniques described above to identify its location in step 410.

At step 415, the television 100 submits its current location in a query to a channel frequency database 180. The query is effectively a request for the database 180 to identify all frequency channels that might be received by the television 100 at its current geographic location. As explained above, the database 180 may be a remote database accessed over a wide area network 170 such as the Internet. Such a database 180 could be accessed directly from the television 100 over its network interface 160. Alternatively, the television 100 could communicate directly with an app running on a smart phone or tablet computer 190. This app could receive the query at step 415 and submit the query to the remotely located database 180. In still another embodiment, the database 180 could be stored locally in the smart phone or tablet computer 190, allowing the device 190 to directly respond to a query from the television 100. In a final embodiment, the television 100 could contain the database 180 internally. This database 180 could be loaded into the non-volatile memory of the television 100 during manufacture of the television 100, or could be downloaded by the television 100 over the network interface 160 and periodically updated. Regardless of how the database 180 is accessed, the database 180 will respond to the query by returning a list of frequencies that may be accessible to the television 100 at its current location. Every television 100 and antenna 110 combination will have different characteristics as to their ability to receive digital television broadcasts. As a result, the list will likely include signals on channel frequencies that will be possible for some antenna 110 and television 100 combinations to receive but would be difficult or near impossible for other combinations.

Once this list is received from the database 180, the television 100 will then scan each of the frequencies on the list to see which signals it can receive. The television 100 will select a first frequency on the list at step 420 and then scan for broadcasts at that frequency in step 425. If a broadcast signal can be received at that frequency, the television will read the signal to obtain virtual channel information and other metadata about the signal (such as the data embedded using the PSIP protocol). The RF frequency, virtual channel information, and other metadata discovered will then be stored in the new channel map at step 430. If the scan at 425 cannot read the broadcast signal at the selected frequency, then step 430 will simply be skipped. At step 435, the method 400 determines if any more frequencies exist in the list returned in step 415. If so, the method returns to step 420 and the next frequency is selected. If not, the channel map is complete. Step 440 makes the new channel map the active channel map for the television tuner 122, and the method 400 concludes. If method 400 was called from with method 300, then step 440 may be skipped as steps 340 and 350 will accomplish the same result.

The many features and advantages of the invention are apparent from the above description. Numerous modifications and variations will readily occur to those skilled in the art. For example, although FIG. 1 shows each DTV signal 160, 162, 164 being broadcast on a separate transmitter antenna 161, 613, 165, respectively, it is possible that multiple broadcast signals on different frequencies could be transmitted simultaneously from a single antenna. Since such modifications are possible, the invention is not to be limited to the exact construction and operation illustrated and described. Rather, the present invention should be limited only by the following claims.

What is claimed is:

1. A digital television comprising:
a) a geographic location identification system;
b) a digital television tuner; and
c) a channel memory containing a plurality of channel scans each channel scan having:
i) an associated geographic location, and
ii) a plurality of frequencies at which the digital television tuner can receive a digital television signal when the digital television is located at the associated geographic location.

2. The digital television of claim 1, further comprising:
d) a processor programmed to:
i) create a new channel scan by:
(1) determining a current geographic location of the digital television using the geographic location identification system;
(2) determining a list of frequencies to scan for digital television signals;
(3) scanning, with the digital television tuner, the list of frequencies to identify selected frequencies at which the tuner detects a digital television signal;
(4) storing in the channel memory the new channel scan containing the selected frequencies and the current geographic location.

3. The digital television of claim 2, wherein the processor is further programmed to:
ii) select an appropriate channel scan among the plurality of channel scans in the channel memory by:
(1) determining the current geographic location of the digital television using the geographic location identification system;
(2) comparing the current geographic location to the associated geographic locations of the channel scans in the channel memory; and
(3) selecting the appropriate channel scan having an appropriate geographic location proximal to the current geographic location;
wherein the digital television tuner uses the appropriate channel scan to determine available television frequencies.

4. The digital television of claim 3, wherein the geographic location identification system comprises a GPS device within the digital television.

5. The digital television of claim 3, wherein the geographic location identification system comprises programming that communicates with a local mobile device, wherein the local mobile device operates an app that determines a mobile device geographic location and communicates the mobile device geographic location to the programming on the digital television.

6. The digital television of claim 3, wherein the geographic location identification system comprises a user input interface on the digital television that allows a user to manually enter the current geographic location for the digital television.

7. The digital television of claim 3, wherein the processor determines the list of frequencies to scan for digital television signals by submitting the current geographic location to a channel frequency database and then receiving the list of frequencies to scan for television broadcasts from the channel frequency database, wherein the received list of frequencies contains only frequencies at which broadcasts are known be transmitted proximal to the current geographic location of the digital television.

8. A method for updating a channel map in a digital television comprising:
a) obtaining a geographic location for the digital television;
b) comparing the geographic location against a plurality of stored channel scans, with each stored channel scan associating a scan location with a channel map;
c) identifying a selected stored channel scan stored in a channel memory of the digital television for the geographic location of the digital television;
d) utilizing the selected channel map in the selected stored channel scan as the channel map for the digital television.

9. A method for creating a channel map comprising:
a) obtaining a geographic location for the digital television;
b) obtaining a list of frequencies to scan for television broadcasts;
c) scanning the list of frequencies to detect television broadcasts using a digital television tuner;
d) creating a new channel map containing the frequencies of the detected television broadcasts; and
e) storing the new channel map in a channel memory of the digital television along with the obtained geographic location of the digital television.

10. A method for creating a channel map comprising:
a) obtaining a geographic location for the digital television;
b) submitting the geographic location to a channel frequency database;
c) receiving a list of frequencies to scan for television broadcasts from the channel frequency database, wherein the received list of frequencies contains only frequencies at which broadcasts are known be transmitted proximal to the geographic location of the digital television;
d) scanning the list of frequencies to detect television broadcasts using a digital television tuner;
e) creating a new channel map containing the frequencies of the detected television broadcasts; and
f) storing the new channel map in a channel memory of the digital television.
